(19) United States
(12) Patent Application Publication
(10) Pub. No.: US 2022/0332200 A1
(43) Pub. Date: Oct. 20, 2022

(54) CHARGING STATION FOR CHARGING AN ELECTRICAL ENERGY ACCUMULATOR OF A ROAD VEHICLE

(71) Applicant: Siemens Mobility GmbH, Muenchen (DE)

(72) Inventors: Florian Buehs, Berlin (DE); Helge Molthan, Bad Feilnbach (DE)

(21) Appl. No.: 17/763,310

(22) PCT Filed: Jul. 20, 2020
(86) PCT No.: PCT/EP2020/070447

§ 371 Date: Mar. 24, 2022

(30) Foreign Application Priority Data
Sep. 24, 2019 (DE) 10 2019 214 552.3

(51) Int. Cl. B60L 53/16; B60L 5/24; B60L 5/36; B60L 53/60

(52) U.S. Cl. CPC B60L 53/16; B60L 5/24; B60L 5/36; B60L 53/60

(57) ABSTRACT

A charging station charges an electrical energy accumulator of a road vehicle. For energy supply from a two-pole overhead line system, the road vehicle has a pantograph with at least one wearing strip, which can be raised and lowered, for each contact pole. For each contact pole, the charging station contains at least two charging contacts which are arranged above a charging position for the road vehicle and are arranged next to each other so that for each contact pole at least two contact points can be established between the wearing strip and the charging contacts. This makes it possible to transmit higher charging currents, which shortens the charging time for the energy accumulator.

The invention relates to a charging station for charging an electrical energy accumulator of a road vehicle.

In charging stations for electrically powered road vehicles with energy accumulators, it is known to supply the charging power, in particular for light passenger vehicles, via a plug-in cable connection.

For electric or hybrid road vehicles, in particular heavy-duty commercial vehicles, it is also known, e.g. from published unexamined German patent application DE 10 2017 203 046 A1, to charge the energy accumulator via a power feed from a two-pole overhead line system by means of a vehicle-mounted pantograph while the vehicle is traveling. The pantograph comprises a framework which supports a bow with two wearing strips for each contact pole. While the vehicle is traveling, the wearing strips of each contact pole are in sliding contact with the contact wires assigned to the respective contact pole so that electrical energy can be supplied both directly for the traction drive and for charging the energy accumulator. In contrast to operation while the vehicle is traveling, when the vehicle is stationary there is no movement of the point of contact between the wearing strip and contact wire and no cooling airstream, so that when the vehicle is stationary the supply current must be low enough to prevent overheating-related damage to the wearing strip and/or contact wire. Charging the energy accumulator while the vehicle is stationary is therefore time-consuming.

The object of the invention is therefore to provide a charging station for charging an electrical energy accumulator of a road vehicle which, for supplying energy from a two-pole overhead line system, has a pantograph with at least one wearing strip per contact pole, which wearing strip can be raised and lowered, said charging station enabling the vehicle to be charged more quickly while stationary.

This object is achieved by a charging station having the features as claimed in claim 1. For charging an electrical energy accumulator of a road vehicle which, for collecting energy from a two-pole overhead line system, has a pantograph with at least one raisable and lowerable wearing strip for each contact pole, the charging station comprises, for each contact pole, at least two charging contacts which are disposed above a charging position for the road vehicle and adjacent to one another in such a way that at least two contact points can be provided between wearing strip and charging contacts for each contact pole. The electrical contact between the overhead line system and the road vehicle is established by a plurality of contact points via which the charging power is delivered. The Joule heat produced per contact point decreases the greater the number of contact points and can dissipate better because of the spatial distribution of the contact points. The sizing of the wearing strips is predetermined based upon constraints in terms of vehicle weight and dimensions, so that the two or more charging contacts allow a higher charging current intensity, which reduces the charging time. Depending on the desired charging current intensity, the number of charging contacts can be varied, wherein two, three or four charging contacts are preferably provided.

In a preferred exemplary embodiment of the charging station according to the invention, at least some of the charging contacts are designed as contact rails which are suspended parallel to one another in a spring-mounted manner in a charging frame and aligned at right angles to the wearing strips of the pantograph of the road vehicle in the charging position. The charging frame can, for example, be supported by a cantilever arm projecting above the loading position, which arm is attached to a charging mast mounted adjacent to the loading position. When the road vehicle is in position, the elongated contact rails are aligned in the longitudinal direction of the vehicle so that, viewed from above, they form a right angle or approximately a right angle with the wearing strips of the pantograph. By further raising the wearing strips after they come into contact with the contact rails, the contact rails are pressed against a restoring force of spring elements. The number and arrangement of the spring elements for each contact rail is selected such that a contact pressure that is as uniform as possible is transmitted over the contact points. The charging station in this exemplary embodiment is suitable for charging positions where there is no overhead line system. The road vehicle proceeds to the charging station in battery or hybrid mode and, when it reaches the charging position, deploys the pantograph to raise the wearing strips to the charging contacts.

In another preferred exemplary embodiment of the charging station according to the invention, for each contact pole, one charging contact is constituted by a contact wire of the overhead line system and the other charging contacts are implemented as contact rails which are suspended in a spring-mounted manner in a charging frame, parallel to the contact wire and at right angles to the wearing strips of the pantograph of the road vehicle in the charging position. The charging station in this exemplary embodiment can be disposed at charging positions on electrified overhead line sections. In this case, the contact wires each act as a charging contact, and the other charging contacts are constituted by contact rails similarly to the exemplary embodiment described above. Said contact rails are held slightly above the contact wires, so that when the pantograph is deployed, the collector strips first lift the contact wires slightly to then make contact with the contact rails.

In another preferred exemplary embodiment, the charging frame of the charging station according to the invention has means for limiting the lifting movement of the wearing strips which define a contact position of the wearing strips in which the spring-mounted charging contacts press against the wearing strip with equal spring force. The limiting means form a mechanical stop for the wearing strips. When this is achieved, the spring elements are deflected approximately uniformly, which ensures uniform distribution of the pressure forces at the contact points between the wearing strips and the charging contacts.

In another preferred exemplary embodiment of the charging station according to the invention, the contact rail length is at least as great as a distance between two contact pole wearing strips disposed one behind the other in the longitudinal direction of the vehicle. This allows both vehicles whose pantographs have only a single wearing strip for each contact pole and those having a pair of wearing strips disposed one behind the other in the longitudinal direction of the vehicle to charge their energy accumulator, wherein in the latter case the road vehicle can be positioned so that each charging contact can be contacted by both wearing strips of a contact pole.

In another preferred exemplary embodiment of the charging station according to the invention, the length of the contact rails is at least twice as great as the distance between two wearing strips of a contact pole which are disposed one behind the other in the longitudinal direction of the vehicle. The longer design of the contact rails makes it possible to provide the driver with a certain tolerance range in the direction of travel when parking his road vehicle at the charging position, which increases the user-friendliness of the charging station according to the invention.

In another preferred exemplary embodiment of the charging station according to the invention, the length of the contact rails is at least as long as the length of the vehicle. Further lengthening of the contact rails enables the charging contacts to make contact with the wearing strips as soon as the charging position is approached, thereby allowing charging to commence before the vehicle comes to a standstill. This in turn shortens the time required for charging the energy accumulator.

In another preferred exemplary embodiment of the charging station according to the invention, for each contact pole, the charging contacts are spaced apart in such a way that the contact points of the charging contacts are located in lateral end sections of the wearing strip. This enables the wearing strips to have different material sections. For example, their middle section, which is heavily used on the overhead line system, can be made of graphite, while the lateral end sections can be made of copper or aluminum.

This enables wear on the contact wires to be minimized. On the other hand, higher charging currents can be transmitted via the lateral end sections, since the contact points between wearing strips and charging contacts are located in the end sections of the wearing strips.

In another preferred exemplary embodiment of the charging station according to the invention, the charging frame is designed to be movable downward against a lifting force of the pantograph when the wearing strips are in contact. If the charging frame is movable downward, the contact force between wearing strips and charging contacts can be increased because, in addition to the restoring forces of the spring elements, a counteract the deployment forces of a lifting device of the pantograph. The higher contact forces improve current transmission.

In another preferred exemplary embodiment, the charging station according to the invention comprises a sensor unit for detecting the wearing strip temperature and a control unit for temperature-dependent charging current control. This allows the charging current to be controlled such that overheating of the wearing strip and the attendant damage are avoided. The charging current can be controlled from the charging station or from the vehicle via suitable communication between the charging station and the vehicle.

Further features and advantages of the invention will emerge from the following description of a specific exemplary embodiment with reference to the accompanying schematic drawings in which

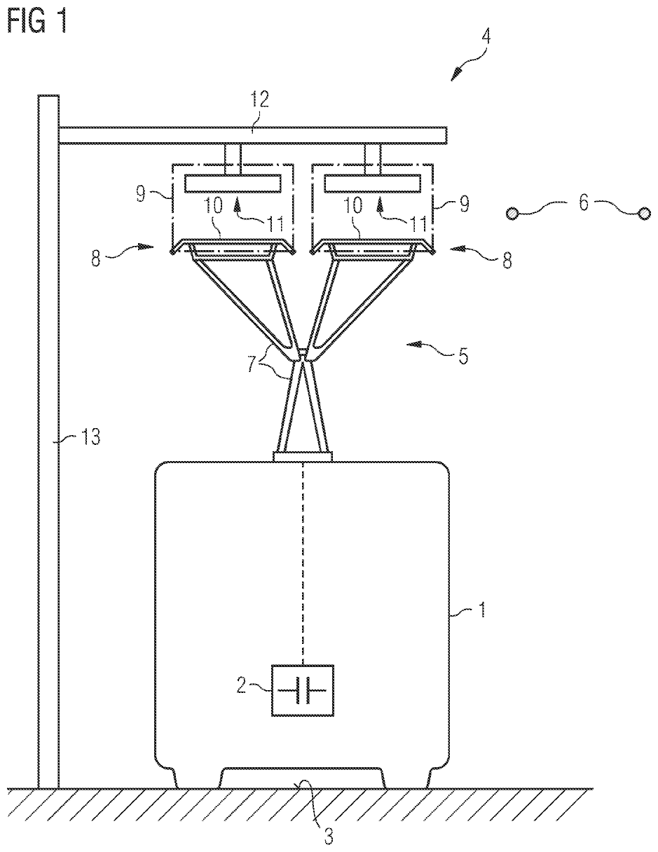

FIG. 1 shows a front view of a road vehicle positioned in a charging station,

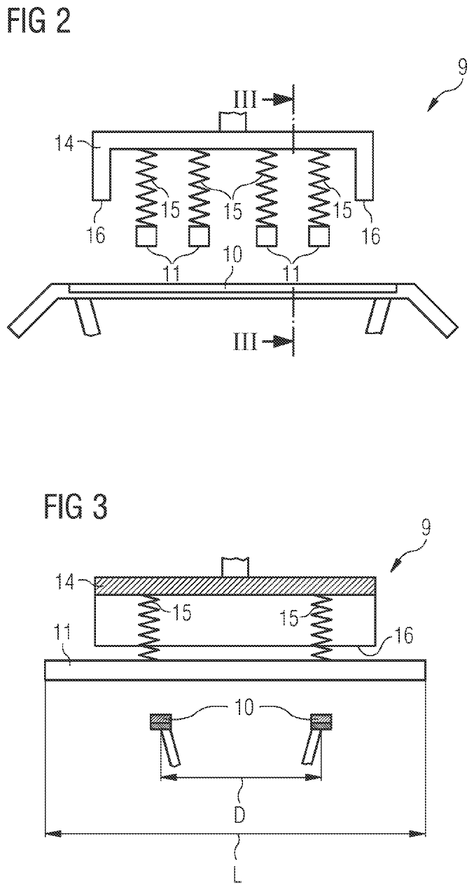

FIG. 2 shows a front view of wearing strips and charging contacts of a contact pole from FIG. 1,

FIG. 3 shows a side view of wearing strips and charging contacts of the contact pole from FIG. 2 in a longitudinal section along the line III-III,

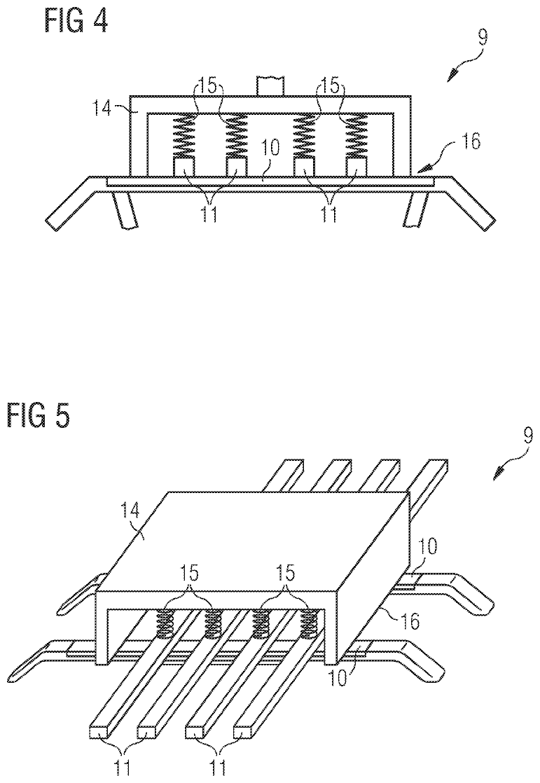

FIG. 4 shows a front view of wearing strips and charging contacts of the contact pole from FIG. 1 in the closed state, and

FIG. 5 shows a perspective view of wearing strips and charging contacts of a contact pole from FIG. 4.

As shown in FIG. 1, an electric or hybrid road vehicle 1, e.g. a heavy-duty commercial vehicle, is positioned in a charging station 4 installed on a roadway 3 for charging its electrical energy accumulator 2. The road vehicle 1 is equipped with a pantograph 5 for supplying energy, while the vehicle is traveling, from a two-pole overhead line system of which, for simplicity's sake, only the contact wires 6 formed as forward and return conductors are shown above a lane of the roadway 3 adjacent to the charging position. The pantograph 5 has a framework 7 which is mounted on the vehicle roof and can be deployed and folded down by means of a lifting device (not shown). The framework 7 supports two bows 8—one for each contact pole 9—disposed side by side as viewed in the longitudinal direction of the vehicle, each of which is equipped with a pair of wearing strips 10 disposed one behind the other as viewed in the longitudinal direction of the vehicle. If the road vehicle 1 uses an electrified lane, the wearing strips 10 can be brought into sliding contact with the respective contact wire 6 by deploying the framework 7 in order to supply energy from the overhead line system to the road vehicle 1.

However, in the exemplary embodiment shown, the charging station 4 is disposed away from an electrified lane and comprises, for each contact pole 9, two or more, e.g. four, charging contacts 11 which are disposed above the charging position for the road vehicle 1. For this purpose, the charging contacts 11 can be connected to a cantilever arm 12 of the charging station 4, said arm projecting above the charging position from a charging mast 13 installed at the side of the roadway 3. The charging voltage is supplied to the charging contacts 11 of the respective contact poles 9 via electrical cables (not shown) running in the charging mast 13 and cantilever arm 12.

As shown in FIG. 2 and FIG. 3, four charging contacts 11 designed as contact rails are spring-mounted in a charging frame 14 for each contact pole 9. The elongated contact rails are aligned parallel to one another and are each connected to the charging frame 14 via e.g. two spring elements 15. Here, the length L of the contact rails is selected significantly greater than the distance D between the wearing strips 10 of a bow 8, which are located one behind the other, so that a tolerance range is available for positioning the road vehicle 1 in the direction of travel. Further extending the contact rails makes it possible to start the charging process even before the vehicle has come to a standstill. By raising the bows 8, the wearing strips 10 push the charging contacts 11 upwards against the restoring force of the spring elements 15 until the wearing strips 10 abut limiting means 16 as shown in FIG. 4 and FIG. 5. The limiting means 16 can be constituted e.g. by side legs of the u-shaped charging frame 14. For each contact pole 9, electrical contact is closed via eight contact points via which a high charging current can flow to shorten the charging time of the energy accumulator 2. In this state, the deflected spring elements 15 ensure that the pressure force between wearing strips 10 and charging contacts 11 is evenly distributed over the contact points. To increase the pressure force, the charging frame 14 can be attached to the arm 12 in a lowerable manner, wherein the charging contacts 11 press down against the lifting force of the pantograph 5.

The large number of contact points ensure that a high charging power can be transmitted because the Joule heat generated per contact point decreases the larger the number of contact points and can dissipate better because of the spacing of the contact points.

The charging contacts 11 shown here are distributed approximately uniformly along the wearing strip 11. Alternatively, the charging contacts 11 can be disposed such that they contact only a lateral end region of the wearing strip 10 when the contact is closed, which region then—in contrast to the central region made of graphite—consists of metal, in particular aluminum or copper. This allows the charging currents to be increased still further.

The charging station 1 can also comprise a sensor unit (not shown here) for detecting a temperature of the wearing strip 10 and a control unit for temperature-dependent charging current control. This enables the charging current to be controlled such that overheating of the wearing strips 10 and damage caused thereby are avoided.

1-10. (canceled)

11. A charging station for charging an electrical accumulator of a road vehicle having a pantograph with contact poles, and for each of the contact poles, at least one raisable and lowerable wearing strip for collecting energy from a two-pole overhead line system, the charging station comprising:
at least two charging contacts for each of the contact poles, said at least two charging contacts are disposed above a charging position for the road vehicle and adjacent to one another in such that at least two contact points can be established between the at least one raisable and lowerable wearing strip and said at least two charging contacts for each of the contact poles.

12. The charging station according to claim 11,
further comprising a charging frame; and
wherein at least some of said charging contacts are configured as contact rails which are suspended in said charging frame in a spring-mounted manner parallel to one another and are aligned at right angles to the at least one raisable and lowerable wearing strip of the pantograph of the road vehicle in a charging position.

13. The charging station according to claim 11,
further comprising a charging frame; and
wherein, for each of the contact poles, one of said charging contacts is constituted by a contact wire of the two-pole overhead line system and another of said charging contacts is implemented as contact rails which are suspended in said charging frame in a spring-mounted manner parallel to the contact wire and are aligned at right angles to the at least one raisable and lowerable wearing strips of the pantograph of the road vehicle in the charging position.

14. The charging station according to claim 12, wherein said charging frame has limiting means for a lifting movement of the at least one raisable and lowerable wearing strip which defines a contact position of the at least one raisable and lowerable wearing strip in which said charging contacts being spring-mounted charging contacts press against the at least one raisable and lowerable wearing strip with equal spring force.

15. The charging station according to claim 12, wherein a length of said contact rails is at least as great as a distance between two raisable and lowerable wearing strips of a contact pole disposed one behind the other in a longitudinal direction of the road vehicle.

16. The charging station according to claim 15, wherein the length of the contact rails is at least twice as great as the distance between the two raisable and lowerable wearing strips, for the contact pole, disposed one behind the other in the longitudinal direction of the road vehicle.

17. The charging station according to claim 15, wherein the length of said contact rails is at least as great as a length of the road vehicle.

18. The charging station according to claim 11, wherein for each of the contact poles, said charging contacts are spaced apart from each other such that said contact points of said charging contacts are located in lateral end sections of the at least one raisable and lowerable wearing strip.

19. The charging station according to claim 12, wherein said charging frame is configured to be movable downward against a lifting force of the pantograph when the at least one raisable and lowerable wearing strip is in contact.

20. The charging station according to claim 11, further comprising:
a sensor unit for detecting a temperature of the at least one raisable and lowerable wearing strip; and
a control unit for temperature-dependent charging current control.
